(19) United States
(12) Patent Application Publication
(10) Pub. No.: US 2012/0205313 A1
(43) Pub. Date: Aug. 16, 2012

(54) Sulfate removal from aqueous waste streams with recycle

(75) Inventors: Karthikeyan Sathrugnan, Singapore (SG); Lew Andrew Reyes, Singapore (SG)

(73) Assignee: SIEMENS INDUSTRY, INC., Alpharetta, GA (US)

(21) Appl. No.: 13/368,860

(22) Filed: Feb. 8, 2012

Related U.S. Application Data
(60) Provisional application No. 61/441,879, filed on Feb. 11, 2011.

(51) Int. Cl. C02F 1/44; B01D 65/02; B01D 61/00

(52) U.S. Cl. 210/652; 210/650; 210/636

(57) ABSTRACT

This invention provides for sulfate removal from a water source by a reverse osmosis (RO) or nanofiltration (NF) process where the concentrate stream is treated to precipitate and remove reject sulfate and recycle the discharged concentrate water and any backwash water used to clean a filter used to prepare feed water for the RO or NF process.

### FIELD OF THE TECHNOLOGY

This invention provides for a process to remove sulfate from a water source, more particularly for a process to remove sulfate by a membrane filtration process with essentially complete recycle of concentrate water and dirty media backwash water.

### BACKGROUND

Acid mine drainage (AMD), sometimes referred to as Acid Rock Drainage, represents a large source of sulfate containing waters. AMD is a common term sometimes used to refer to any mine operation discharge, many of which are alkaline. The primary source of AMD is from the mining industry. Other sources include flue gas scrubbing at power stations, highway construction and other deep excavations. AMD arises from the oxidation of iron pyrite, FeS₂, and other sulfidic minerals by exposure to water and oxygen. Pyrite is the most abundant sulfide mineral on earth and many mineral sulfides are associated with the presence of pyrites. Coal deposits may contain 1% to about 20% of mineral sulfides and organic sulfur. AMD may be neutral to acidic, and may contain variable amounts of dissolved heavy metals, but always contains sulfate.

High concentrations of sulfates in water sources present problems to wetlands and their wildlife inhabitants. Sulfates can stimulate microbial sulfate reduction (MSR) wherein sulfate reducing bacteria (SRB) produce sulfide from sulfate in the course of degrading inorganic matter. Deleterious effects of high levels of sulfates are the generation of hydrogen sulfide and the accelerated release of nitrogen and phosphorous from soils, termed autoeutrophication.

The traditional treatment of AMD is with lime and limestone to neutralize acidity and precipitate out calcium sulfate (gypsum). However, relatively high levels of sulfate remain. Depending on composition and ionic strength, sulfate concentrations of about 1500 mg/l to up to 4000 mg/l, may remain after such treatments. Calcium content is also high due to the lime treatment, and there are other metal ions present as well.

A review of sulfate treatment processes are described in Chapter 3 of “Treatment of Sulphate in Mine Effluents”, October 2003, a final report from International Network for Acid Prevention (INAP) Salt Lake City, Utah 84109 USA. Chemical, membrane ion exchange and biological mechanisms are described. The report can be found at

http://www.inap.com.au/public_downloads/Research_Projects/Treatment_of_Sulphate_in_Mine_Effluents_-_Lorax_Report.pdf

and in Chapter 7 of the GARD Guide http://www.gardguide.com

Cost effective methods and apparatus are sought to reduce effluent concentrations of sulfate to below 500 mg/l, and more preferably below 250 mg/l. A useful guideline is that the EPA Secondary Drinking Water Regulations recommend a maximum concentration of 250 mg/l for sulfate ions. Many of the water sources generating AMD are located at remote sites, requiring compact and low energy usage systems. Furthermore, waste disposal has to be controlled to prevent despoiling natural resources.

U.S. patent application Ser. No. 12/926,143 describes a sulfate removal process having ion exchange, reverse osmosis and gypsum and calcium carbonate precipitation and recovery process steps.

U.S. patent application Ser. No. 13/119,275 describes a sulfate removal process using a reverse osmosis and a desaturation/clarification step, but no recovery of multimedia backwash.

The inventive process accomplishes sulfate removal by membrane desalination and precipitation of the sulfate in the concentrate, Waste disposal is an important aspect of any AMD mitigation process and must account for sludge and concentrate disposal. Sludge refers to the residual semisolid resulting from precipitation of sulfate or other material in the concentrate and dirty water recycle process described later. Reducing the amount of sludge and/or concentrate will reduce disposal costs. The primary method of reducing sludge volume is by concentration by dewatering. Depending on sludge composition, sludge may be disposed of in sludge ponds, backfill for underground mines, disposal with mine tailings and waste or incorporation into rehabilitation covers of mine tailings and waste.

Concentrate, also called reject or brine, disposal presents a more challenging aspect of waste disposal. The volume of concentrate may be up to 30%-50% of the influent feed stream, and it will contain all the removed sulfate and other ions. In the case of nanofiltration, the concentrate will have a high ratio of di- and tri-valent ions, as monovalent ions will tend to pass the membrane.

In operation, the sulfate removal process runs at essentially 100% recycle so that no concentrate is released. Sulfate in the concentrate is precipitated and the precipitate dewatered and concentrated. These steps greatly reduce operational cost and reduce the impact on the environment.

### SUMMARY DESCRIPTION

Embodiments of the invention provide for a process to remove sulfate from a water source by filtering the inlet water with a backwashable suspended solids filter, separating the filtered water with a pressurized membrane process to produce a sulfate depleted permeate and a concentrate containing the removed sulfate and other removed species, and further treating the concentrate and any dirty water produced during the backwashing of the suspended solids filter, to produce a sulfate filter cake and a clarified recycle water stream which is returned to the process inlet.

In an embodiment, the backwashable filter is a multimedia filtration apparatus.

In an embodiment, the backwashable filter is an ultrafiltration or microporous membrane filtration apparatus.

In an embodiment, the pressurized membrane process is a reverse osmosis process.

In an embodiment, the pressurized membrane process is a nanofiltration process.

In an embodiment, sulfate is removed from the concentrate stream by precipitation, preferable by ferric chloride and gypsum seeding.

In an embodiment, the precipitated sulfate is dewatered and concentrated, preferably by a filter press.

### BRIEF DESCRIPTION OF THE FIGURES

FIG. 1 shows a schematic of an embodiment of the process with a flashmixer/clarifier process for recycle of process water.

FIG. 2 shows a schematic of an embodiment of the process with a sludge thickener/clarifier step.

### DETAILED DESCRIPTION

The inventors have conceived and reduced to practice a water treatment process for sulfate removal with essentially total process recovery. Process recovery is defined as the ratio of membrane filtration permeate flow to the raw water feed flow plus any recycle water flow. Raw water feed is the portion of the influent water to the process that comes from the water source to be treated. The total water influent to the water treatment process consists of the raw water feed and recycled water as will be described. In the process described essentially all concentrate liquid and water used to backwash multimedia filtration equipment or other pretreatment filters is recycled and returned to the influent of the overall process after undergoing a sulfate removal process.

By “essentially total” is meant that the inventive process continuously recycles all water except for minor losses in normal operation. As will be described, some water is lost with the dewatered sludge, and on some occasions, may be lost in brine release. However, in normal operation, the bulk of water is released in the purified permeate from the membrane separation process, with minimal concentrate or brine release.

Influent water is typically collected in a feed storage tank and then prepared for membrane filtration. Turbidity and suspended solids in the feed water are removed. Multimedia filtration is typically used, but ultrafiltration and/or microporous membrane filtration may be used to affect this, followed by a cartridge polishing filter as needed. Antiscalant chemicals are added as needed and pH is adjusted to optimize recovery. The filtered and treated feed is fed to a reverse osmosis or nanofiltration membrane water purification system. Purified permeate water is stored in a Permeate Storage Tank from which the water may be sent to approved disposal. A portion of the permeate is used for flushing lines and for the multimedia backflushing process step.

The membrane filtration process removes dissolved ions. The choice of membrane is dictated by the ions to be removed. Seawater membranes are used to desalinate seawater (equivalent to approximately 35,000 ppm NaCl) at pressure of 800-1500 psi. This type of membrane will retain over 99% of incident salt. Brackish water membranes operate at lower pressures in waters of lower ionic strength. They will have relatively lower inherent retention of salt ions, but have a higher permeability and when properly engineered, will operate economically. They are used to remove all ions to over 90% removal. Nanofiltration (NF) membranes are so-called “loose” reverse osmosis membranes which retain multivalent ions and species of greater than about 400 molecular weight. NF generally pass a high percentage of monovalent ions. They have relatively higher permeability than RO membranes.

In a RO or NF process, a continuous flow of feed water contacts across one side of the membrane at an elevated pressure. The pressure is above the osmotic pressure of the feed water, generally multiples of the osmotic pressure. Purified water passes through the membrane to the low pressure side of the process as permeate. The retained sulfate and other salts and organic matter removed from the feed water are concentrated in the concentrate stream.

The influent water must be pretreated to prepare it for membrane filtration. Water is prepared to remove material that will harm the membrane or decrease the effectiveness of the membrane filtration. Removal of suspended solids is a primary purpose of pretreatment. Two methods are commonly used, multimedia filters and ultrafiltration (UF) and/or microporous (MF) membrane filtration. Multimedia filters remove suspended solids from water. As water flows downward through the bed, it encounters layers of filtration media with decreasing porosity, the coarse media layers in the top of the tank trap large particles, and successively smaller particles are trapped in the finer layers of media deeper in the bed. Successively smaller particles are then trapped in each layer, thus providing true depth filtration. A common multimedia filter may have layers of coarse and fine gravel, garnet, sand, and anthracite.

UF and MF systems may be spiral wound modules (UF), pleated cartridges (MF) or hollow fibers cartridges (UF or MF). Hollow fiber or cartridges are preferred because they can be run in a dead-end mode and backwashed.

To operate the process at high recoveries, practitioners use chemicals termed anti-sealants to prevent precipitation of ions of marginal solubility. Common anti-sealants are proprietary mixtures commonly containing polycarboxylic acids, polyacrylic acid and phosphino carboxylic acid polymers. Optimal molecular weights have been reported in the range of 1,000-3,500. Other polyelectrolytes sometimes used are polyphosphonates and polyphosphates. These chemicals prevent precipitation of calcium and other salts at the membrane surface as the feed is concentrated at the high pressure side of the reverse osmosis membrane, thereby maintaining permeate productivity. However, the presence of anti-scalants in the desaturation tank will reduce the effectiveness of metal removal by desaturation. Therefore, a balance is required between reducing fouling in the RO step and increasing or maintaining desaturation efficiency.

When adding antiscalants, it is common practice to add acid or base as needed to optimize the pH of the water being treated. The antiscalant addition and pH adjustment is termed conditioning. A preferred range is about 3 to 10, with a more preferred range of about 5 to about 7, and a most preferred range of from about 6 to about 7.

The primary purpose of the membrane process step is to concentrate and remove sulfate, while passing purified water to downstream fate. For this type of application, nanofiltration is a preferred process. A properly designed NF system will remove over 95% of incoming sulfate ions at a high rate of permeation. However, in water remediation the fate of the concentrate flow is equally important to the process because it cannot be simply released to the environment. In the present process, the sulfate in the concentrate stream is further concentrated by flocculation and precipitation into a sludge, which is dewatered and disposed of in an approved manner. The water from the multimedia backwashing and rinsing, overflow from the sulfate precipitation and water released in sludge dewatering is treated in a clarifying process and recycled to the front of the process and combined with influent sulfate feed water.

The overall membrane step can be engineered in a variety of conformations, depending on the amount of water to be processed, the feed concentrations and the required output. Reverse osmosis system design is the topic of several books, such as The Guidebook to Membrane Desalination Technology Reverse Osmosis, Nanofiltration and Hybrid Systems Process, Design, Applications and Economics (Wilf, M., et al; Desalination Publications).

While practitioners commonly may use once-through flow in reverse osmosis operations, practitioners also use concentrate recirculation, where the concentrate is returned to the feed storage tank. In relatively small applications, such as waste water, where intermittent or non-continuous discharge is used, a batch or semi-batch method is common. A batch operation is one in which the feed is collected and stored in a tank or other reservoir, and periodically treated. In semi-batch mode, the feed tank is refilled with the feed stream during operation.

The RO system may have single or multiple stages. In a single stage system, the feed passed through one or more pressure vessel arrange in parallel. Each pressure vessel will have one or more membrane modules in series. The number of stages is defined as the number of single stages the feed passes through before exiting the system. Permeate staged systems use permeate from the first stage as feed for the second stage, and if multiple stages are used, permeate from a stage just prior is used as feed for the following stage. In as reject staged system, the reject stream of a stage is sent to become the feed stream of a subsequent, usually the next, stage. Reject, concentrate and retentate and similar terms have synonymous meanings in RO processing.

In operating the process described herein, the permeate and raw feed flows have to be equal over an extended period of operating time. This is explained by the consideration that since essentially all concentrate is recycled, along with backwash water as required, if the raw feed flow and the permeate flows become unbalanced, there will be an increase or decrease of water in the recycle system. If the permeate flow is less than the raw feed water flow, there will be an increase in the water in the recycle system, which may overwhelm the process tank volumes, or deleteriously affect the precipitation. If the permeate flow is greater than the raw feed water flow, then there will be a withdrawal of recycle water volume and this may result in increased salt concentration in the recycle and poor precipitation and may affect membrane separation by increased osmotic pressure.

The operator therefore is required to manage and control the flows to attain equal permeate and raw feed water flows on average. This is a different operating method than standard desalination of waste treatment where the process is usually run to maximize process recovery with allowance for fouling and osmotic pressure build-up.

The membrane or multimedia pretreatment filters are backwashed with permeate water when accumulated solids increase pressure drop through the filtration system. The dirty backwash water is collected and treated in the recycle process. The dirty backwash water contains removed suspended solids.

In an alternative embodiment of the inventive process, the membrane or multimedia pretreatment filters are backwashed with water filtered through an auxiliary membrane or multimedia filter.

In the reaction tank, the concentrate stream from the membrane process is reacted with ferric chloride, FeCl₃, to neutralize the effect of the added antiscalant and promote calcium sulfate precipitation. Calcium chloride, CaCl₂, is also added to this stream to assure that sufficient calcium is available for complete calcium sulfate precipitation. Sodium hydroxide may be added to adjust pH. The reacted sulfate flows by gravity to a Sludge Thickener Tank where a polymer flocculent or precipitation aide is added. Solid sulfate precipitate is removed as required from the tank bottom and sent to a filter press for dewatering.

A portion of the sludge is returned to the reaction tank to seed sulfate precipitation.

Dewatering may be done by several methods. Examples of standard methods of filtration are leaf filtration, rotary drum filtration, rotary disk filtration, horizontal belt or horizontal table filtration may also be used. These and other methods are described in standard texts, for example; Perry's Handbook 7^{th} Edition (McGraw-Hill NY).

In a preferred method, a filter press concentrates the slurry to a solid cake by removing water from the slurry by filtration. (dewatering) The process is a batch process. Slurry is fed into a series of connected volumes having a plate on each side with a cloth filter on each side of the so-formed volume. As the filtration proceeds, the solids contents in each volume increases until a cake is formed. The filter press is depressurized and opened and the cake is sequentially discharged by shifting each plate one at a time.

The liquid removed during the dewatering process is sent to the clarifier, described elsewhere, to be recycled.

Overflow or discharge water from the sludge thickener tank, and water removed in dewatering from the filter press are combined with the dirty backflush water and treated in a recycle process. This water is mixed with a polymer flocculent in a flash mixer. In the flash mixer, the added polymer is vigorously mixed to evenly distribute the polymer, so that micro-flocs are produced. The use of a flash mixer increases flocculation efficiency and reduces polymer use. From the flash mixer the mixed water and polymer is gravity fed to a cone bottom clarifier. The solids in the bottom are sent to the sludge thickener step, and the clarified water is returned to the head of the process to be combined with incoming sulfate containing water.

Cation accumulation is a side effect of the present process since most of the calcium and magnesium is retained and much of the sodium is rejected as well. At some point this will affect the nanofiltration system, either by an increased osmotic pressure, or by scaling. Since the volume of concentrate in the system at this time will be a small fraction of the total volume treated, the operator may choose to incorporate this volume into a mine waste or tailing stream, or into a solar evaporation pond or other approved disposal streams.

The operator may also choose to precipitate the calcium and magnesium cations by lime (Ca(OH)₂) and sodium carbonate addition, for example. In this case, the operator may close the raw water inlet and recycle nanofiltration permeate to the feed storage tank while the precipitate is dewatered and removed as described for sulfate removal.

Once the calcium and magnesium content are lower sufficiently, the process will be returned to the normal operating mode.

The inventors have found that the inventive sulfate removal process may be operated at essentially total recycle. This mode of operation results in minimal liquid brine or concentrate release, resulting in a lower cost process that has a much reduced effect on the environment.

### DETAILED PROCESS DESCRIPTION

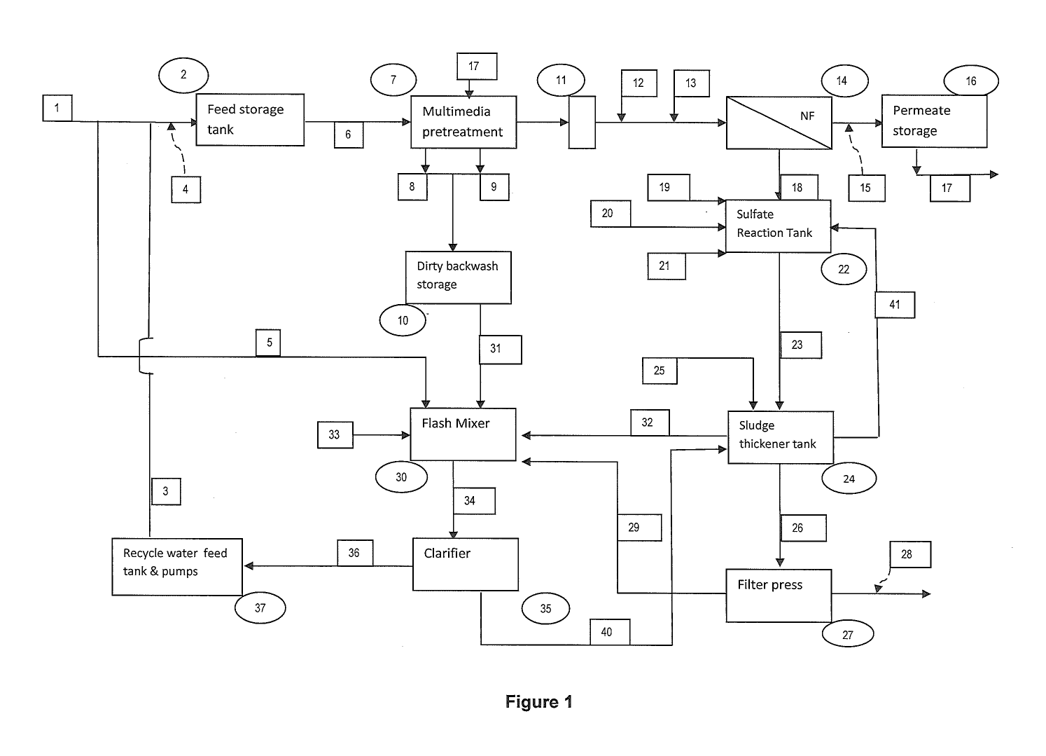

The following description refers to FIG. 1. Liquid flows are indicated by arrows. Pumping equipment is not shown for simplicity.

Sulfate containing water, as from an acid mine drainage source, is pumped through feed line 1 to the Feed Storage Tank 2. Recycled process water may be added to the sulfate containing feed water through line 3 to become the influent feed water, 4. If the sulfate containing feed water has a turbidity higher than a predetermined specification, all or a portion of this flow may be sent to the clarifier process (described further) by line 5.

Water from Tank 2 is pumped through line 6 to a multimedia filtration system 7 to remove suspended solids. As solids accumulate in the multimedia filtration system, the pressure required to maintain flow will increase. At a predetermined pressure, or periodically, as determined by the plant operator, the multimedia system is backwashed with permeate water from the membrane water purification process. Backwashing is done by flowing clean water 17 in the reverse, i.e., upward direction, to remove collected debris and to reswell the media. After the backwash is complete, water from the feed storage tank is quickly rinsed through the media. The dirty water and rinse water is pumped 8, 9 to a Recycle Tank 10 for clarification and recycle back through the process.

After passing through the multimedia filtration, feed water may be further filtered by a polishing cartridge filter 11. Antiscalant is added 12 to increase the solubility of calcium sulfate so that fouling of the membrane surface will not occur. Acid, typically hydrochloric acid is added 13 to adjust pH and optimize sulfate removal.

A preferred antiscalants is PC504T (Nalco Company 1601 W. Diehl Road Naperville, Ill. 60563-1198 U.S.A.) Concentrations higher than generally recommended for brackish water are preferred, preferred range being between about 10 to about 30 mg/liter with a preferred concentration being approximately 17 mg/liter. It is critical that fresh solutions of antiscalant be used.

The treated water is pressurized and sent to the NF system 14 where it is contacted with the NF membranes. Purified permeate passes through the membranes and is sent to a permeate storage tank 16 via line 15. Permeate water is sent to existing ponds or other approved destinations. A portion of the stored permeate water is used for multimedia backwashing via line 17, as described, or for rinsing sludge lines.

The reject or concentrate stream containing concentrated sulfate is sent by line 18 to the sulfate reaction tank 22. Ferric chloride 19 and calcium chloride 20 are added and the reaction allowed to proceed for a suitable time. Sodium hydroxide 21 or other suitable base may be used to adjust pH. Reaction time is measured by average residence time in the reaction tank, the ratio of the tank volume to average flow rate through line 18.

The concentrate with the now-reacted sulfate is sent to the Sludge Thickener Tank 24 via line 23 and polymer flocculating agent 25 added. The thickener tank is typically tank with a cone bottom. The precipitated sulfate is removed by gravity settling. Gravitational settling is a simple method of sludge removal. Settling rate may be increased by using flocculating agents. Cationic, anionic or non-ionic flocculants may be used. Acrylamide polymers, polyaminoacrylate polymers and sulphonated polystyrene are among the types of flocculants typically used. However, care must be taken to assure these agents do not accumulate excessively in the clarifier overflow being returned to the RO feed, as these polymers may cause fouling.

The preferred separation method for the concentrate stream is precipitation or co-precipitation and settling with removal of the clarified water by overflow from the precipitation vessel. Precipitation is also termed sedimentation, desaturation, or thickening. The clarified water is sent to the Flash Mixer 30 via line 32.

Preferred coagulants include ferric sulfate, ferrous chloride and aluminum salts, such as polyaluminum chloride, aluminum sulfate, aluminum chloride, etc., or calcium sulfate. More preferred coagulants are ferric chloride and calcium sulfate (gypsum) precipitate. A most preferred coagulant is a blend of ferric chloride and precipitated gypsum.

Ferric chloride is hydrolyzed in alkaline water to form several products which incorporate Fe(OH)₃ having high cationic charge density. This allows for neutralization of charge of colloidal compounds, negatively charged particles and also self aggregation. In this way floc aggregates are formed. Ferric chloride flocs form more discrete and dense flocs, giving better sedimentation.

In embodiments of the present inventive process, ferric chloride has been found to be particularly useful because it inhibits the antiscalant left in the concentrate and thereby maximizes desaturation or precipitation of sulfate. Ferric chloride may be used in concentrations as low as 10 ppm, and at pH values as low as of about 4 to about 5.

Added ferric chloride concentrations of 10 mg/liter to 400 mg/liter are a preferred range. Lower concentrations have proven useful, in the concentration range of 10-200 mg/liter, even to 10-25 mg/liter. Since each AMD feed will be different, the practitioner will use these ranges to find an optimum range for their particular case.

Seeding the reject with gypsum precipitate is also a preferred method of precipitating the reject stream. Gypsum precipitation is best done at the maximum sulfate concentration possible. Preferred seed concentrations are between about 0.4% to about 3%. Fresh gypsum particles or seeds are highly preferred. These are taken from the sludge stream and added to the reactor 22. A pH range of about 3 to about 6 has been found to be satisfactory.

The sulfate precipitate sinks to the bottom of the thickener tank and is collected in the cone bottom. As required the solids are removed and sent by line 26 to a filter press 27 or other dewatering process. A preferred dewatering process is a filter press with a automatic or semi-automatic plate shifter using fabric filter cloths.

Clarified water overflows the top of the sludge thickener tank and is discharged to the flash mixer 30 of the recycle process by line 32.

A portion of the sludge is returned to the reaction tank 22 via line 41 to seed sulfate precipitation.

The dewatered solids are sent to waste 28.

Water from the dewatering process is sent by line 29 to the Flash Mixer 30, which is a step in the recycle process. The dirty backwash water is sent to the flash mixer through line 31, to be mixed with the overflow from the sludge thickener tank by line 32 and the liquid flow from the filter press by line 29. Polymer flocculating agent 33 is usually added. The contents of the flash mixer are sent to the clarifier 35 through line 34. The clarifier is a cone bottom tank with inclined parallel plate packs. Any solids that do not settle into the cone section accumulate as they contact the plates and drop into the cone when they gain sufficient mass. The solids layer is sent by line 40 to the thickener tank when there is enough mass, where it eventually ends up in the filter press. The liquid from the clarifier overflow goes to the Multimedia Feed 37 Tank through line 36. The multimedia feed tank contents are pumped through line 3 to the influent inlet line 4 to combine with the sulfate ladened feed water.

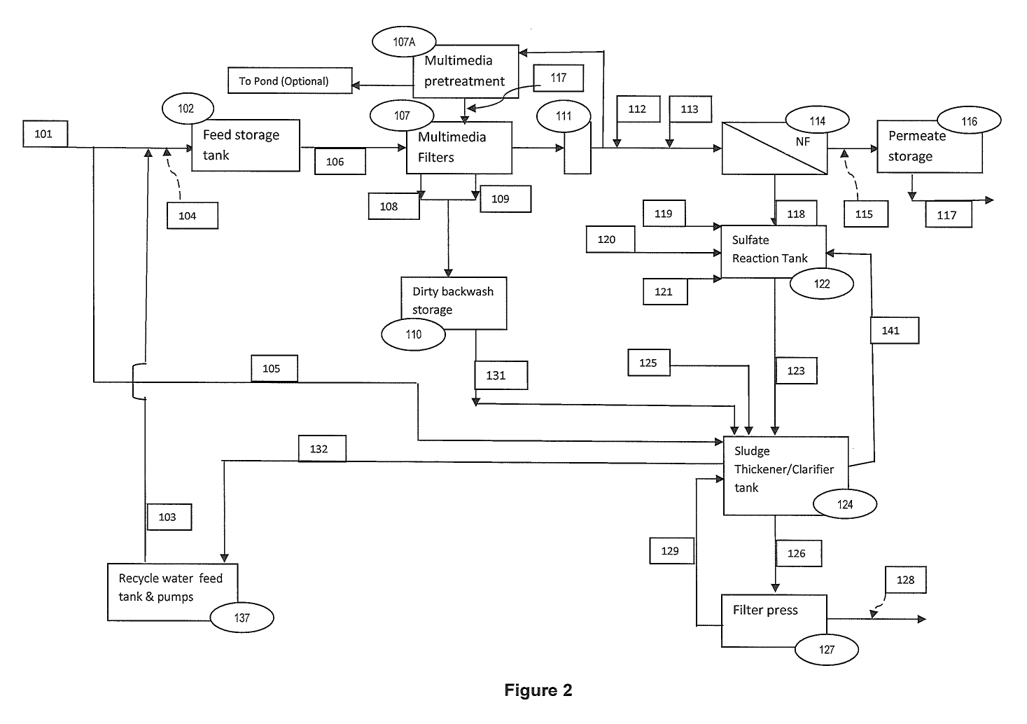

The following description refers to FIG. 2. This process is a version of the process illustrated in FIG. 1. Liquid flows are indicated by arrows. Pumping equipment is not shown for simplicity.

Sulfate containing water, as from an acid mine drainage source, is pumped through feed line 101 to the Feed Storage Tank 102. Recycled process water is added to the sulfate containing feed water through line 103 to become the influent feed water, 104. If the sulfate containing feed water has a turbidity higher than a predetermined specification, all or a portion of this flow may be sent to the clarifier process (described further) by line 105.

Water from Tank 102 is pumped through line 106 to a multimedia filtration system 107 to remove suspended solids. As solids accumulate in the multimedia filtration system, the pressure required to maintain flow will increase. At a predetermined pressure, or periodically, as determined by the plant operator, the multimedia system is backwashed with water filter by auxiliary backwashable filter 107A. Backwashing is done by flowing clean water 117 in the reverse, i.e., upward direction, to remove collected debris and to reswell the media. After the backwash is complete, water from the feed storage tank is quickly rinsed through the media. The dirty water and rinse water is pumped 108, 109 to a Recycle Tank 110 for clarification and recycle back through the process.

In this embodiment of the inventive process, the backwash water is sent by line 131 to the sludge thickener/clarifier tank for precipitation. Solids precipitated from this steam are combined with precipitated sulfate and sent to the filter press, 127, by line 126.

After passing through the multimedia filtration, feed water may be further filtered by a polishing cartridge filter 111. Antiscalant is added 112 to increase the solubility of calcium sulfate so that fouling of the membrane surface will not occur. Acid, typically hydrochloric acid is added 113 to adjust pH and optimize sulfate removal.

A preferred antiscalants is PC504T (Nalco Company 1601 W. Diehl Road Naperville, Ill. 60563-1198 U.S.A.) Concentrations higher than generally recommended for brackish water are preferred, preferred range being between about 10 to about 30 mg/liter with a preferred concentration being approximately 17 mg/liter. It is critical that fresh solutions of antiscalant be used.

The treated water is pressurized and sent to the NF system 114 where it is contacted with the NF membranes. Purified permeate passes through the membranes and is sent to a permeate storage tank 116 via line 115. Permeate water is sent to existing ponds or other approved destinations—line 117.

The reject or concentrate stream containing concentrated sulfate is sent by line 118 to the sulfate reaction tank 122. Ferric chloride 119 and calcium chloride 120 are added and the reaction allowed to proceed for a suitable time. Sodium hydroxide 121 or other suitable base may be used to adjust pH. Reaction time is measured by average residence time in the reaction tank, the ratio of the tank volume to average flow rate through line 118.

The concentrate with the now-reacted sulfate is sent to the Sludge Thickener Tank/Clarifier 124 via line 123 and polymer flocculating agent 125 added. The thickener/clarifier tank is typically tank with a cone bottom. The precipitated sulfate is removed by gravity settling. Gravitational settling is a simple method of sludge removal. Settling rate may be increased by using flocculating agents. Cationic, anionic or non-ionic flocculants may be used. Acrylamide polymers, polyaminoacrylate polymers and sulphonated polystyrene are among the types of flocculants typically used. However, care must be taken to assure these agents do not accumulate excessively in the clarifier overflow being returned to the RO feed, as these polymers may cause fouling.

The preferred separation method for the concentrate stream is precipitation or co-precipitation and settling with removal of the clarified water by overflow from the precipitation vessel. Precipitation is also termed sedimentation, desaturation, or thickening. The clarified overflow water is sent by line 132 to a recycle water storage tank 137 and pump for addition via line 103 to the influence stream 104.

Preferred coagulants include ferric sulfate, ferrous chloride and aluminum or calcium sulfate. More preferred coagulants are ferric chloride and calcium sulfate (gypsum) precipitate. A most preferred coagulant is a blend of ferric chloride and precipitated gypsum.

Ferric chloride is hydrolyzed in alkaline water to form several products which incorporate Fe(OH)₃ having high cationic charge density. This allows for neutralization of charge of colloidal compounds, negatively charged particles and also self aggregation. In this way floe aggregates are formed. Ferric chloride flocs form more discrete and dense flocs, giving better sedimentation.

Added ferric chloride concentrations of 10 mg/liter to 400 mg/liter are a preferred range. Lower concentrations have proven useful, in the concentration range of 10-200 mg/liter, even to 10-25 mg/liter. Since each AMD feed will be different, the practitioner will use these ranges to find an optimum range for their particular case.

Seeding the reject with gypsum precipitate is also a preferred method of precipitating the reject stream. Fresh gypsum particles or seeds are highly preferred. These are taken from the sludge stream and added to the reactor 122 by line 141. The amount to be added will depend on how the reject stream responds to the seeding, but a starting point is 25 to 50 grams of gypsum seeds/liter. A pH range of about 3 to about 6 has been found to be satisfactory.

Gypsum precipitation is best done at the maximum sulfate concentration possible. This requires that the RO stages be optimized to obtain the maximum level of sulfate possible consistent with proper operation of the RO system. Seeding the reaction solution with gypsum particles is a preferred method to obtain higher removal efficiency. Seed concentration added to aid precipitation will vary depending on conditions such as sulfate concentration, time required by other process scheduling requirements and other conditions. Preferred seed concentrations are between about 0.4% to about 3%.

The sulfate precipitate sinks to the bottom of the thickener tank 124 and is collected in the cone bottom. As required the solids are removed and sent by line 126 to a filter press 127 or other dewatering process. A preferred dewatering process is a filter press with an automatic or semi-automatic plate shifter using fabric filter cloths.

Clarified water overflows the top of the sludge thickener tank 124 and is discharged to the flash mixer of the recycle process by line 132.

A portion of the sludge is returned to the reaction tank 122 via line 141 to seed sulfate precipitation.

Water from the dewatering process is sent by line 129 to the sludge thickener/clarifier tank 124. The dewatered solids are sent to waste by line 128.

1. A sulfate removal process for sulfate containing water with essentially total concentrate recycle comprising the steps of;
a) treating filtered sulfate containing water with a membrane separation process to separate the sulfate containing into a sulfate depleted permeate and a sulfate enriched concentrate, and,
b) removing sulfate from the concentrate by precipitation, and,
c) recycling sulfate removed concentrate to the membrane separation process.

2. The process of claim 1 wherein the membrane filtration process is a reverse osmosis process.

3. The process of claim 1 wherein the membrane filtration process is a nanofiltration process.

4. The process of claim 1 wherein the sulfate containing water is filtered with a backwashable filtering process, and backwash water is treated by a process comprising a precipitation agent to remove a major portion of suspended solids from the backwash water, and the resulting suspended solids removed backwash water recycled to the membrane separation process.

5. The process of claim 4 wherein the backwashable filtering process comprises a multimedia filter

6. The process of claim 4 wherein the backwashable filtering process comprises a membrane filtration process.

7. The process of claim 6 wherein the backwashable filtering process comprises a ultrafiltration process.

8. The process of claim 6 wherein the backwashable filtering process comprises a microporous membrane process.

9. The process of claim 1 wherein the process recovery is greater than about 95%.

10. The process of claim 1 wherein the process recovery is greater than about 99%.

11. A sulfate removal process with concentrate and backwash recycle for sulfate containing water comprising the steps of;
a) preparing the influent water for a membrane separation process with a backwashable filtering process,
b) filtering the prepared water with an membrane filtration process to separate an influent sulfate containing water into a reduced sulfate containing permeate and a concentrate containing removed sulfate,
e) separating the concentrate into a sulfate sludge and discharged water,
d) reducing the sludge to a water reduced solid and removed sludge water,
e) combining the removed sludge water with the discharged water of step c., and used backwash water from the pretreatment step, to form a recycle feed water,
f) separating the recycle feed liquid of step e. into a clarified recycle water and a solids containing liquid, and,
g) returning the solids containing liquid of step f. to the concentrate to be separated in step b., and
h) adding the clarified recycle liquid to sulfate containing water to form the influent sulfate containing water.

12. The process of claim 11 wherein the membrane filtration process is a reverse osmosis process.

13. The process of claim 11 wherein the membrane filtration process is a nanofiltration process.

14. The process of claim 11 wherein the backwashable filtering process is a multimedia filtration process.

15. The process of claim 11 wherein the backwashable filtering process is a membrane filtration process.

16. The process of claim 15 wherein the backwashable filtering process is a ultrafiltration process.

17. The process of claim 15 wherein the backwashable filtering process is a microporous membrane process.

18. The process of claim 11, wherein the membrane filtration process comprises the steps of adjusting and controlling the pH of the prepared water entering the membrane filtration process to a range of from about 5 to about 7, adding a calcium sulfate scale formation inhibitor in a concentration range of from about 10 mg/l to about 30 mg/l, and passing the pH controlled and inhibitor added water through a membrane process to separate the water into a reduced sulfate containing permeate and a concentrate containing removed sulfate.

19. The process of claim 18 wherein the calcium sulfate scale formation inhibitor is Nalco PermaTreat® 504T.

20. The process of claim 11 wherein the concentrate from the membrane process is separated into a sulfate rich sludge and a residual sulfate poor liquid by the steps of;
a) treating the concentrate stream with ferric chloride and calcium chloride, precipitate from the sludge thickener vessel, and optionally an inorganic hydroxide base in a reactor vessel for an average residence time sufficient to form calcium sulfate precipitates,
b) transferring the treated stream to a sludge thickener vessel, adding a polymeric agglomeration agent and collecting settled precipitated calcium sulfate sludge,
c) transferring a portion of the settled precipitated calcium sulfate sludge to the reactor vessel, and,
d) transferring the resulting sulfate poor liquid to a clarifier recycle process.

21. The process of claim 11 wherein the settled precipitated calcium sulfate sludge is reduced to a water reduced solid and a residual sludge liquid by dewatering the sludge and transferring the removed water to a clarifier recycle process.

22. The process of claim 11 wherein recyclable liquid is produced by the steps of;
a) combining dirty backwash water, residual sludge water and the residual sulfate poor liquid from the sludge thickener vessel in a mixing vessel,
b) adding a polymeric flocculating of agglomerating agent,
c) transferring the mixture after a suitable residence time to a clarifier vessel,
d) separating the mixture into settled solids and water for recycle,
e) transferring the settled solids to the sludge thickener tank, and,
f) transferring the water for recycle to the influent of the sulfate removal process.

23. The process of claim 21 wherein dewatering is accomplished by a filter press using fabric filter cloths with an automatic plate shifter.

24. The process of claim 11 wherein the process recovery is greater than about 95%.

25. The process of claim 11 wherein the process recovery is greater than about 99%.

26. A membrane filtration sulfate removal process with concentrate and backwash recycle for sulfate containing water comprising the steps of;
a) treating the influent water feed with a backwashable multimedia filtration process, wherein water used in backwashing is sent to a clarifier process for recycle,
b) adjusting and controlling the pH of the prepared water entering the membrane filtration process to a range of from about 5 to about 7, adding a calcium sulfate scale formation inhibitor in a concentration range of from about 10 mg/l to about 30 mg/l, and passing the pH controlled and inhibitor added water through a membrane process to separate the water into a reduced sulfate containing permeate and a concentrate containing removed sulfate,
c) separating the concentrate from the membrane process into a sulfate rich sludge and a discharge water by the steps of;
i) treating the concentrate stream in a reactor vessel with ferric chloride, calcium chloride and a portion of the precipitate from the sludge thickener vessel, and optionally an inorganic hydroxide base in a reactor vessel for an average residence time sufficient to form calcium sulfate precipitates,
ii) transferring the reacted stream to a sludge thickener vessel, adding a polymeric agglomeration agent and collecting settled precipitated calcium sulfate sludge,
iii) transferring a portion of the settled precipitated calcium sulfate sludge to the reactor vessel,
iv) transferring the settled sludge to a filter press, and,
v) transferring the discharge water from the sludge thickener tank to a clarifier process for recycle,
d) dewatering the sludge in the filter press to produce a sludge cake and removed water, and, transferring the removed water to a clarifier process for recycle,
e) combining dirty backwash water, removed sludge water and the residual sulfate poor liquid from the sludge thickener vessel in a mixing vessel,
f) adding a polymeric flocculating of agglomerating agent,
g) transferring the mixture after a suitable residence time to a clarifier vessel,
h) separating the mixture into settled solids and water for recycle, transferring the settled solids to the sludge thickener tank, and,
i) transferring the water for recycle to the influent of the sulfate removal process.

27. The process of claim 26 wherein the membrane filtration process is a reverse osmosis process.

28. The process of claim 26 wherein the membrane filtration process is a nanofiltration process.

29. The process of claim 26 wherein the backwashable filtering process is a multimedia filter process.

30. The process of claim wherein the backwashable filtering process is a membrane filtration process.

31. The process of claim 30 wherein the backwashable filtering process is a ultrafiltration process.

32. The process of claim 30 wherein the backwashable filtering process is a microporous membrane process.

33. The process of claim 31 wherein the backwashable filtering process is a hollow fiber ultrafiltration process.

34. The process of claim 33 wherein the backwashable filtering process is a hollow fiber microporous membrane process.

35. The process of claim 26 wherein the process recovery is greater than about 95%.

36. The process of claim 26 wherein the process recovery is greater than about 99%.
